(19) United States
(12) Patent Application Publication
(10) Pub. No.: US 2008/0157625 A1
(43) Pub. Date: Jul. 3, 2008

(54) Development of a low driving-voltage micro scratch drive actuator by ultra-low resistivity silicon wafer

(75) Inventors: Alex Horng, Kaohsiung City (TW); I-Yu Huang, Kaohsiung City (TW); Yen-Chi Lee, Kaohsiung City (TW); Chun-Ying Lin, Kaohsiung City (TW)

Correspondence Address: BACON & THOMAS, PLLC, 625 SLATERS LANE, FOURTH FLOOR, ALEXANDRIA, VA, 22314, US

(73) Assignee: Sunonwealth Electric Machine Industry Co., Ltd., Kaohsiung City (TW)

(21) Appl. No.: 11/790,718

(22) Filed: Apr. 27, 2007

(30) Foreign Application Priority Data
Dec. 28, 2006 (TW) 95149601

(51) Int. Cl. H02N 11/00; C01B 33/02; H01H 57/00

(52) U.S. Cl. 310/300; 200/181; 423/348

(57) ABSTRACT

Based on the voltage-division theory, this invention proposes a new method to decrease the driving voltage of the micro scratch drive actuator (SDA) by using an ultra-low resistivity silicon wafer as substrate. This patent has compared two SDA actuators with the same layout and fabricating processes but under different resistivity of substrate. The SDA fabricated on the ultra-low resistivity silicon wafer has demonstrated a lower driving voltage of only about 4˜12 Vₒ₋ₚ. However, the conventional SDA using normal silicon wafer needs higher driving voltage (30˜75 Vₒ₋ₚ), thus has lower probability for commercial applications. On the other hand, this invention presents a new SDA process to overcome the inherent 2 μm line-width limitation of conventional mask aligner with 4360 Å UV wavelength light source (g-line) and further to reduce the driving voltage of SDA.

### FIELD OF THE INVENTION

This invention proposes two methods to decrease the driving voltage of the micro scratch drive actuator, including the use of an ultra-low resistivity silicon wafer as SDA substrate and the decrease of the line-width of the bushing and supporting beam of SDA. The major technology adopted in this patent is the polysilicon-based surface micromachining process of microelectromechanical systems (MEMS) technology, with the advantages of batch fabrication, low cost and high compatibility with integrated circuit technology.

### BACKGROUND OF THE INVENTION

The development and application of the miniaturization technology is the major trend of modern science. In particular, the integrated circuits (IC) and microelectromechanical systems (MEMS) technologies are the rudimentary methods of the microscopic world in the recent years. The world's smallest micro fan device in the world with dimension of 2 mm×2 mm (as shown in Appendix 1) is constructed by self-assembly micro blades and micro micro scratch-drive actuators (SDAs). The SDA actuated micro fan is fabricated by using polysilicon based surface micromachining technology (multi-user MEMS processes, MUMPs) as Appendix 2 shows. An implemented micromotor chip is shown in Appendix 3.

Many researches and applications of SDA device have been reported in previous literatures. For instance, Terunobu Akiyama and his co-workers have first proposed the electrostatic controlled stepwise motion (i.e., scratch drive actuator) in polysilicon micro-slider, micro-motor and X/Y stage. As their experimental results show, the velocity of the microstructures is a function of applied pulse frequency and the step length is a function of the peak value of applied pulse and the length of SDA-plate. They also present a new basic reshaping technology to realize three dimensional silicon microstructures.

On the other hand, Ryan J. Linderman and Victor M. Bright proposed a novel MEMS-based micro rotary fan by using solder self-assembly and SDA technologies. Their papers demonstrated an electrostatically-driven MEMS rotary fan that can be further reduced in size and weight by bulk-etching the motor substrate—leaving only a thin structural layer to support the motor and fan blade array. The critical design aspects of SDA devices are the dimensions of the structural polysilicon layer, the bushing, the dielectric layer and the supporting beams. The optimized dimensions adopted in their micro-fan design are: a SDA-plate of 78 μm long by 65 μm wide, a bushing height of 1.5 μm; the 1.5 μm-thick supporting beams has 4 μm wide and 30 μm long.

The SDA micro rotary motor has been developed for more than one decade, however, such device has limited commercial applications due to its high driving voltage. To overcome this disadvantage, this patent aims to develop a low-driving-voltage micro-SDA device by using an ultra-low resistivity silicon wafer as SDA substrate and to decrease the line-width of the bushing and supporting beam of SDA.

FIG. 1 illustrates the basic operating mechanism of SDA. According to the descriptions of Bright and Linderman, the stepwise motion begins with the free end of SDA-plate (10) electrostatically loaded with the snap through voltage resulting in the plate tip snapping down to touch the nitride dielectric layer (12). When the power increased to the priming voltage, the plate tip will be deflected enough to flatten to a zero slope at the free end. Finally, as the applied power was removed, the strain energy stored in the supporting beams, SDA-plate and bushing (11) will pull the SDA-plate forward to complete the step. This steeping motion can be repeated at frequencies up to 15 kHz in air environments.

FIG. 2 shows the 3-D SDA structure and layout designed in this patent. To improve the driving voltage of the micro SDA, this invention adds the etch holes layout in the layout design of SDA-plate. Once the etch holes are added to the layout of conventional SDA plate, the releasing of structure layer can be accelerated and the accumulated residual charges in the front end of SDA plate is reduced. In this innovative design, a longer lifetime and lower driving voltage of the SDA device can be achieved.

FIG. 3 shows the new substrate and processes of SDA adopted in this invention, where we use an ultra-low resistivity silicon wafer (0.001-0.004Ω-cm) as the new substrate of SDA device and decrease the line-width of the bushing and supporting beam of SDA varied from 2 μm to 1.5 μm by using an additional deposition process of the 0.25 μm-thick 2^{nd} sacrificial layer.

### SUMMARY OF THE INVENTION

Based on the voltage-division theory, this invention proposes a new method to decrease the driving voltage of the micro scratch drive actuator (SDA) by using an ultra-low resistivity silicon wafer as substrate. This invention also presents a new SDA process to overcome the inherent line-width limitation of conventional mask aligner with 4360Å UV wavelength light source and further to reduce the driving voltage of SDA.

This patent has compared two SDA actuators (single SDA-plate) with the same layout and fabricating processes but under different resistivity of substrate. The single-plate SDA on the low resistivity wafer has demonstrated a lower driving voltage of only about 4˜12 Vₒ₋ₚ. However, the conventional SDA using normal silicon wafer (20Ω-cm) needs higher driving voltage (30˜75 Vₒ₋ₚ), thus has lower probability for the commercial applications.

### BRIEF DESCRIPTION OF THE DRAWINGS

FIG. 1 is a schematic diagram showing the basic operating mechanism of conventional scratch drive actuator.

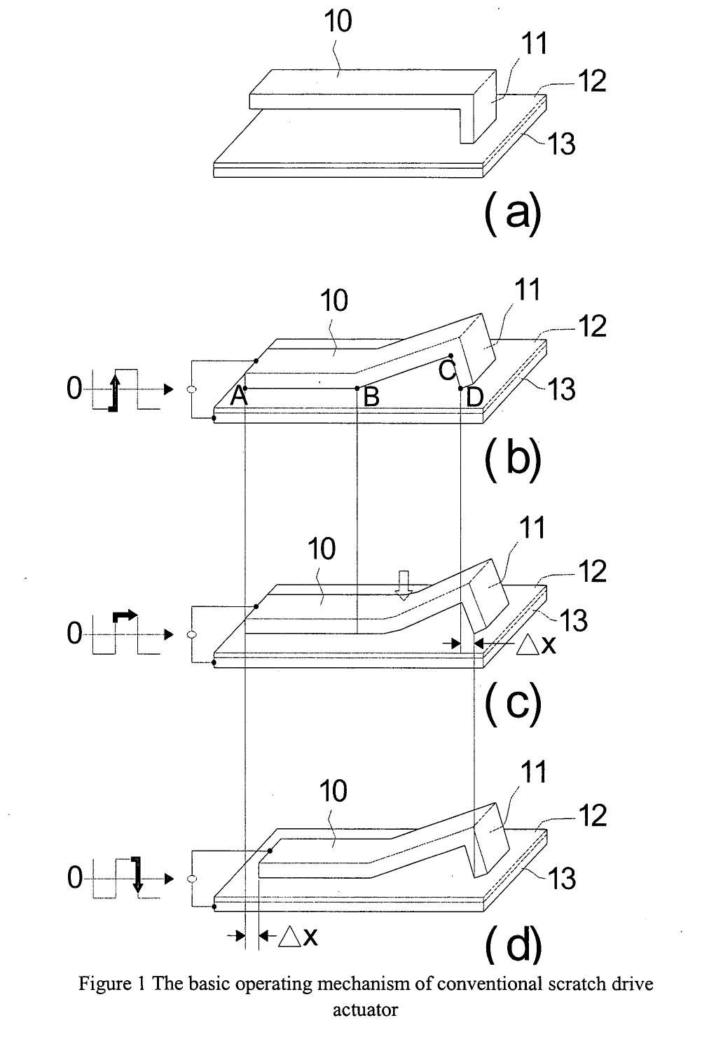

FIG. 2 shows the 3-D structure and layout design of SDA device presented in this invention. The etch-holes and dimple designs have added in the layout of SDA-plate for the reduction of driving voltage.

FIG. 3 is a schematic diagram showing the main processing steps of SDA (with 1.5 μm-wide bushing) adopted in this patent.

FIG. 4 is an illustration showing the influence of driving voltage on two different resistivity of SDA-substrate.

FIG. 5 is an illustration showing the influence of driving voltage on three different shapes and four length/width ratios of SDA-plate.

### BRIEF DESCRIPTION OF THE MAIN DEVICE SYMBOL

(10) SDA-plate

(11) Bushing

(12) Insulator

(13) Silicon substrate

(20) Ultra-low resistivity silicon substrate

(21) Insulator

(22) Anchor area

(23) 1^{st} low-stress sacrificial layer

(24) 2 μm wide dimple area

(25) 2 μm wide bushing area

(26) 2^{nd} low-stress sacrificial layer

(30) Structure layer

(31) 1.5 μm wide dimple

(32) 1.5 μm wide bushing

(41) Top electrode

(42) Bottom electrode

### APPENDIX

Appendix 1: A miniaturized micro fan device fabricated by MEMS technology and constructed by self-assembly micro blades and micro micro scratch-drive actuators (SDAs).
Appendix 2: MEMSCAP's Multi-user MEMS processes (MUMPs)
Appendix 3: An implemented micromotor chip

### DETAILED DESCRIPTION OF THE PREFERRED EMBODIMENT

SDA based devices have limited commercial applications due to its high driving voltage. To overcome this disadvantage, this patent aims to develop a low-driving-voltage micro-SDA device by using an ultra-low resistivity silicon wafer as SDA substrate and decrease the line-width of the bushing and supporting beam of SDA.

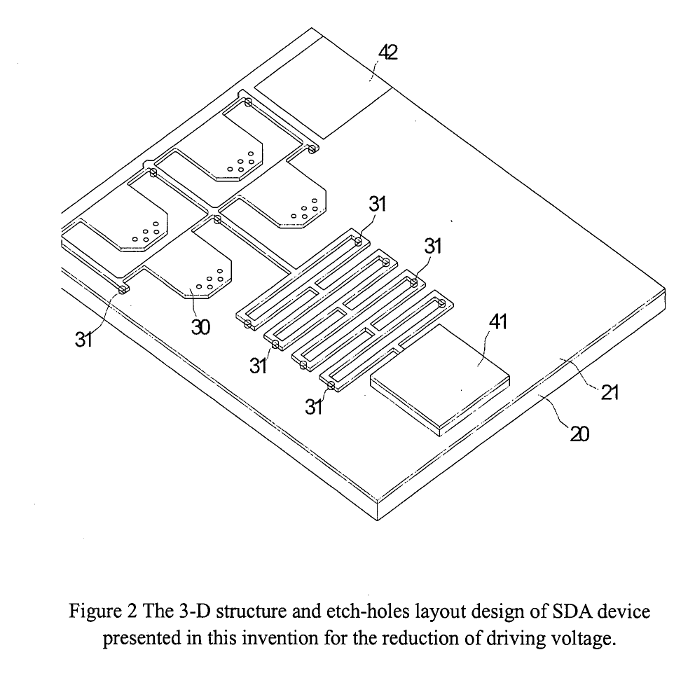

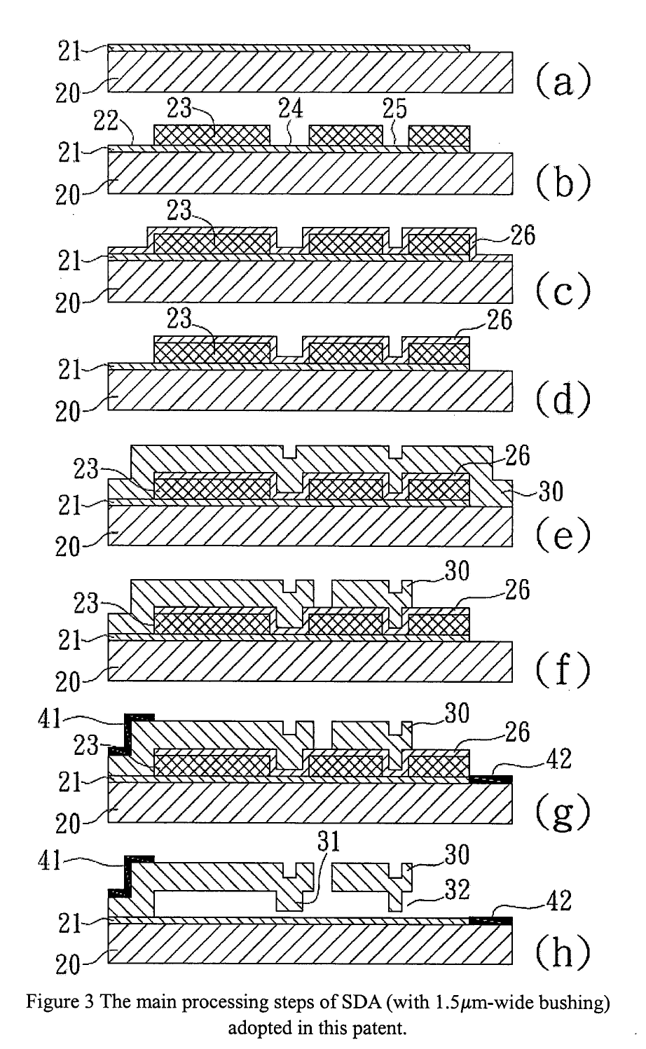

The novel layout and processes designs proposed in this patent are shown in FIG. 2 and FIG. 3, which can effectively reduce the driving voltage of SDA devices. In this innovative design, a longer lifetime and lower driving voltage of the SDA device can be achieved.

FIG. 2 shows the 3-D SDA structure and layout designed in this patent. To improve the driving voltage of the micro SDA, this invention adds the etch holes layout to the conventional layout design of SDA-plate. On the other hand, to reduce stiction effect, many micro dimples have been designed in this invention as shown in FIG. 2.

FIG. 3 shows the new substrate and processes of SDA adopted in this invention, where we use an ultra-low resistivity silicon wafer (0.001-0.004Ω-cm) as the new substrate of SDA device and decrease the line-width of the bushing and supporting beam of SDA ranging from 2 μm to 1.5 μm by using an additional deposition process of the 0.25 μm-thick 2^{nd} sacrificial layer. The complete processing steps at least require five photomasks and the major fabricating technology adopted in this invention is the polysilicon-based surface micromachining process. The main processing steps are described as following:
(a) Reactive ion etching (RIE) of the 600 nm-thick low-stress silicon nitride (21) insulator are deposited on an ultra-low resistivity silicon substrate (20).
(b) Plasma-enhanced chemical-vapor deposit (PECVD) a 1.5 μm-thick PSG sacrificial layer (23) onto the surface of insulator layer (21) and using RIE system to pattern the areas of anchor (22), dimple (24) and bushing (25).
(c) Deposit a 0.25 μm-thick 2^{nd} PSG sacrificial layer (26) by using PECVD system to modify the width of bushing from 2 μm to 1.5 μm.
(d) After the third photolithography process, the 2^{nd} PSG sacrificial layer (26) will be patterned by an inductive-coupling plasma (ICP) etching system.
(e) Deposit a 2 μm-thick polysilicon structural layer (30) onto the 2^{nd} PSG sacrificial layer (26) by using a low-pressure chemical vapor deposition (LPCVD) system and proceeded with the POCAL diffusion and stress annealing processes in a horizontal furnace.
(f) After the fourth photolithography process, the 2 μm-thick polysilicon structural layer (30) will be patterned by an inductive-coupling plasma (ICP) etching system.
(g) Deposit 100 nm/30 nm-thick Au/Cr multi metal layers on the wafer by an electron-beam evaporator system. Use the fifth photolithography process and wet etching process to define the pattern of top (41) and bottom electrodes (42).
(h) Wet-etch the PSG sacrificial layers (23, 26) and release the polysilicon structure layer (30) of the SDA device.

The complete layout design of the micro SDA at least requires five photomasks and the major fabricating technology adopted in this invention is the polysilicon-based surface micromachining processes.

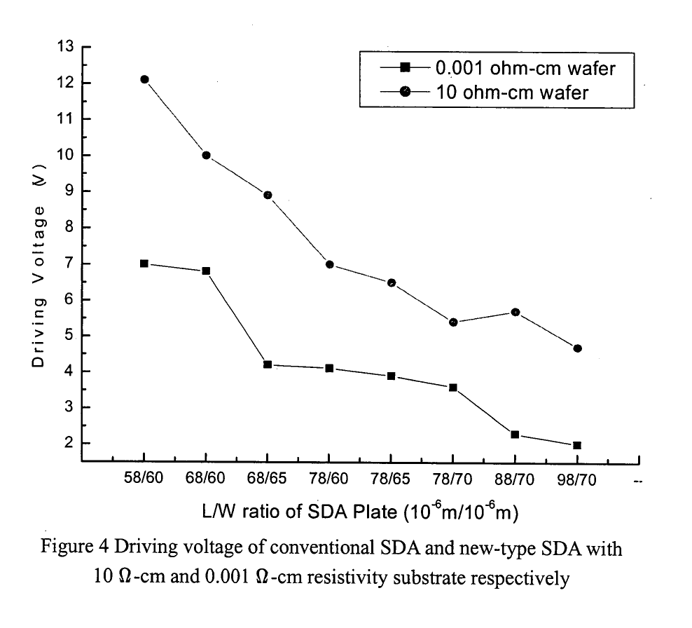

As FIG. 4 shows, the driving voltage of this invention using an ultra-low resistivity silicon substrate (0.001 Ω-cm) is much smaller than that of the previous researches using the normal silicon wafer (10 Ω-cm) as SDA substrate.

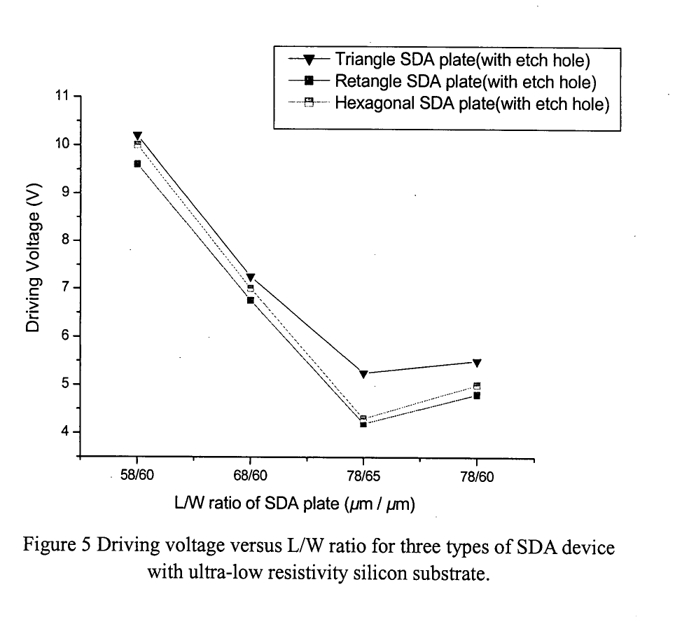

To investigate the optimized geometric parameters of the SDA plate, this patent has compared the influence of driving voltage on SDA-plate of three different shapes and four length/width ratios. In the testing results as depicted in FIG. 5, triangle SDA plate has higher driving voltage than the rectangle shape. Although the SDA-plate added with etching-holes can accelerate the release of structure layer and reduce the accumulated charges, however, it will slightly increase the driving voltage of SDA micromotor. The optimized dimension of the SDA-plate is clearly indicated in FIG. 5. When the ratio of plate length and plate width is equal to 78/65, the smallest driving voltage can be obtained.

What is claimed is:

1. An innovative material and process used to reduce the driving voltage of micro scratch drive actuators, includes
a. Adopting an ultra-low resistivity silicon wafer as the new substrate material of SDA device.
b. Decreasing the line-width of the bushing and supporting beam of SDA by adding an additional deposition process in normal SDA process to overcome the inherent line-width limitation (2 μm) of conventional g-line mask aligner.

2. An innovative layout of micro scratch drive actuators includes
a. At least three new shapes of SDA plate, including the triangle SDA plate with etch-holes design, rectangle SDA plate with etch-holes design and hexagonal SDA plate with etch-holes design. Once the etch holes added to the layout of conventional SDA plate, the releasing of structure layer can be accelerated and the accumulated residual charges in the front end of SDA plate is reduced.
b. At least four different length/width ratios of SDA-plate have been designed in this patent, including 58 μm/60 μm, 68 μm/60 μm, 78 μm/60 μm and 78 μm/65 μm.

3. The ultra-low-resistivity silicon wafer mentioned in claim 1 refers that its resistivity is under the range of 0.001˜0.004 Ω-cm.

4. The SDA device with the novel material and process as mentioned in claim 1 can be applied to the development of SDA micro motor.

5. The SDA device with the novel layout designs as mentioned in claim 2 can be applied to the development of SDA micro motor.

6. The SDA device with the novel material and process as mentioned in claim 1 can be applied to the development of SDA-based micro fan.

7. The SDA device with the novel layout designs as mentioned in claim 2 can be applied to the development of SDA-based micro fan.

8. The SDA device with the novel material and process as mentioned in claim 1 can be applied to the development of micro thermal module/system assembly.

9. The SDA device with the novel layout designs as mentioned in claim 2 can be applied to the development of micro thermal module/system assembly.

10. The SDA device with the novel material and process as mentioned in claim 1 can be applied to the development of micro device/structure assembly.

11. The SDA device with the novel layout designs as mentioned in claim 2 can be applied to the development of micro device/structure assembly.

12. The SDA device with the novel material and process as mentioned in claim 1 can be applied to the development of micro fluid system.

13. The SDA device with the novel layout designs as mentioned in claim 2 can be applied to the development of micro fluid system.

14. The SDA device with the novel material and process as mentioned in claim 1 can be applied to the development of optical/telecommunication micro switch.

15. The SDA device with the novel layout designs as mentioned in claim 2 can be applied to the development of optical/telecommunication micro switch.
